(19) United States
(12) Patent Application Publication
(10) Pub. No.: US 2020/0233446 A1
(43) Pub. Date: Jul. 23, 2020

(54) CONTROL LEVER DEVICE FOR A DRIVING OPERATION OF A VEHICLE

(71) Applicant: Dr. Ing. h.c. F. Porsche Aktiengesellschaft, Stuttgart (DE)

(72) Inventor: Georg von Tardy-Tuch, Unterreichenbach-Kapfenhardt (DE)

(73) Assignee: Dr. Ing. h.c. F. Porsche Aktiengesellschaft, Stuttgart (DE)

(21) Appl. No.: 16/748,848

(22) Filed: Jan. 22, 2020

(30) Foreign Application Priority Data
Jan. 23, 2019 (DE) 102019101647.9

(51) Int. Cl. G05G 1/04; G05G 1/62; G05G 7/00

(52) U.S. Cl. CPC G05G 1/04; B62D 1/12; G05G 7/00; G05G 1/62

(57) ABSTRACT

Control lever device for a driving operation of a vehicle, having a base body with a fastening interface for fastening in the interior of the vehicle in a fastening position, and a control lever having an elongate extent along a control axis. The lever is movably mounted on the base body in a neutral position for a tilting movement in at least one tilting direction about an axis of rotation which, in the fastening position, has an acute first control angle to a direction of travel axis of the vehicle for an inclination of the control lever from the neutral position transversely to the direction of travel axis of the vehicle.

### CROSS-REFERENCE TO RELATED APPLICATION

This application claims priority to German Patent Application No. 10 2019 101 647.9, filed Jan. 23, 2019, the content of such application being incorporated by reference herein in its entirety.

### FIELD OF THE INVENTION

The present invention relates to a control lever device for a driving operation of a vehicle and to a vehicle having such a control lever device.

### BACKGROUND OF THE INVENTION

It is known that, as an alternative to the conventional steering wheels, vehicles can be steered with control lever devices, so-called joysticks. Such control levers can be used, for example, to activate the forward-rearward direction of the vehicle or to control acceleration and braking operations. It is also known that a lateral tilting or rotation of such a joystick makes possible steering movements for a steering angle to the left and/or to the right.

A disadvantage with the known solutions is that the orientation of such control lever devices is usually uncomfortable. They can therefore be used over a relatively long time period only in a fatigue-inducing manner, with the result that they have not been able to gain acceptance in vehicles to date. Apart from the fatigue factor, the known control lever devices lack the sensitivity which is necessary during maneuvering operations or during fine movements of the vehicle.

### SUMMARY OF THE INVENTION

It would be desirable to at least partially eliminate the disadvantages described above. In particular, it would be desirable to improve the ergonomics of a control lever device in a cost-effective and simple manner.

Here, features and details which are described in conjunction with the control lever device according to aspects of the invention self-evidently also apply in conjunction with the vehicle according to aspects of the invention and vice versa in each case, and therefore reference is or can be made constantly from one to the other in respect of the disclosure of the individual aspects of the invention.

According to aspects of the invention, a control lever device serves for a driving operation of a vehicle. For this purpose, such a control lever device has a base body with a fastening interface for fastening in the interior of the vehicle in a fastening position. Furthermore, the control lever device is equipped with a control lever having an elongate extent along a control axis, which lever is movably mounted on the base body in a neutral position for a tilting movement in at least one tilting direction about an axis of rotation which, in the fastening position, has an acute first control angle to a direction of travel axis of the vehicle for an inclination of the control lever from the neutral position transversely to the direction of travel axis of the vehicle.

According to aspects of the invention, a control lever device is thus used in order to control or to steer or to regulate the driving operation of the vehicle at least in one tilting direction. For this purpose, the control lever device is designed for assembly and fastening in the interior of the vehicle. By virtue of the fact that the fastened base body has a fastening interface, the mechanical fastenability ensures a clear orientation in the fastening position in the vehicle. This then allows the final orientation of the control lever with respect to the vehicle to be predetermined by an orientation of the control lever with respect to the base body and to the fastening interface and to be subsequently predefined for the assembly.

According to aspects of the invention, it is then thus possible, when assembling the control lever device, to predetermine at least one predefined tilting direction which, in the form of the acute first control angle to the axis of rotation, tilts the control lever in the installed and assembled fastening position from the neutral position transversely to the direction of travel axis of the vehicle.

Vehicles are customarily defined with a vehicle-fixed coordinate system. This vehicle-fixed coordinate system has three axes which are composed of a direction of travel axis along the vehicle, a transverse axis transverse to the direction of travel axis, and a vertical axis perpendicular to the plane between the direction of travel axis and transverse axis. According to aspects of the invention, the inclination in the fastening position for the control axis thus occurs with respect to the direction of travel axis and the transverse axis. Here, this inclination relates to the neutral position of the control lever. In other words, the axis of rotation of the control lever, in the fastened state of the control lever device, that is to say with respect to the direction of travel, is situated in a forwardly or downwardly inclined manner in the vehicle.

This forwardly or downwardly inclined orientation of the axis of rotation affords a large number of advantages. Whereas in known solutions the axis of rotation was customarily installed along the main axis of the vehicle, an inclination in the direction of travel axis in the downward direction is now provided. During the movement about this axis of rotation, this then means that improved ergonomics can be achieved. In particular it is possible, when the control lever is gripped in its neutral position and subsequently moved along the at least one tilting direction, for a combination of a tilting movement and of a rolling movement of the vehicle user's arm and hand to be carried out. This in turn means that combined movements of the arm also use combined muscle groups. The combination of two different muscle groups in the user's arm, namely a rolling movement and a tilting movement, then allows the control lever to be operated in a considerably more sensitive manner. It is thus possible for one of the two muscle movements to perform the stabilization work, while the second muscle group is available for the tilting movement and hence the control movement. By comparison with the solutions known hitherto, this splitting among two separate muscle groups allows, by virtue of the positioning along the direction of travel axis, a fatigue-free or low-fatigue operation of the vehicle over a relatively long time period and at the same time also a very sensitive and intuitive operating capability. A further advantage results from the fact that the handle follows the combined tilting-rolling movement of the hand and the arm. It is in this way possible for tensile loading or undesired rotations between the control lever and the hand to be reduced or even avoided.

The aforementioned advantages are above all achieved with very simple means which can be realized in the vehicle in a cost-effective manner. Thus, the control lever itself and its electrics or electromechanics can be made available in a simple manner as a standard component. The inclination is ensured by the corresponding installation, with the result that a cost-effective and simple solution can afford the advantages according to aspects of the invention in this way. The base body itself serves, with the fastening interface, for a defined orientation during the final assembly, that is to say during the arrangement of the control lever device in the interior of the vehicle.

It should also be pointed out that the control lever device can of course also have more than the at least one tilting direction. Thus, two opposite tilting directions, for example for the control of the acceleration and the braking of the vehicle, are also conceivable within the context of the present invention.

Advantages can be afforded if, in a control lever device according to aspects of the invention, the first control angle between the axis of rotation and direction of travel axis or forearm axis of the driver's forearm is designed to be in a range of about 45°±15°. A selection of such an angle affords a number of advantages and particularly improves the already explained advantages relating to ergonomics. A situation is avoided in which the control lever is inclined too far forward such that the ergonomic advantages would again entail disadvantages. At the same time, however, the inclination is sufficient in order also in fact to be able to achieve the advantages to the desired degree. Not least, a control angle in this range of this embodiment also affords assembly advantages, since it is possible in this way for the compactness of the structural unit of the control lever device to be improved.

It is also advantageous if, in a control lever device according to aspects of the invention, the axis of rotation has an acute second control angle to a plane formed from the direction of travel axis about the vertical axis, in particular in a range between ±5° and ±10°. If the control lever is situated laterally next to the driver, where it can customarily be arranged, that is to say in the door region and/or in the central console region, this second acute control angle means a rotation toward the driver or away from the driver. In this embodiment, the control lever is oriented with its axis of rotation in space, namely firstly along the direction of travel axis in the forward direction and secondly rotated laterally about the vertical axis. The advantages explained according to aspects of the invention in terms of the ergonomics can be still better achieved in this way. This lateral inclination further increases the effect of the splitting among the different muscle groups, with the result that the freedom from fatigue can be improved and the sensitivity considerably increased.

Further advantages are afforded if, in a control lever device according to aspects of the invention, the control lever has, along the at least one tilting direction, a tilting freedom which is designed to be less than 90°. The advantages are made available not only for the neutral position but also for the extreme positions in the direction of the at least one tilting direction. Here, all the tilting directions preferably have the same or substantially the same tilting clearance. These advantages can thus be simultaneously achieved for all tilting directions and hence also for all control functions.

It can also be advantageous if, in a control lever device according to aspects of the invention, the tilting clearance is designed to be in the range between ±5° and ±45° about the axis of rotation. In a similar manner to what has already been explained for the first control angle and the second control angle, what is concerned in this range of the tilting clearance is a portion which is sufficiently large for a fine adjustment and small enough for a sufficient compactness. Here, the tilting clearance can, in terms of its size, preferably be dependent on the length of the control lever. A shorter control lever will preferably be equipped with a correspondingly larger tilting clearance.

Further advantages can be achieved if, in a control device according to aspects of the invention, the base body and/or the control lever have/has a variation device for a variation possibility of the first control angle. This makes it possible to make available not only in principle the advantages according to aspects of the invention in terms of the ergonomics but also to allow an ergonomic adaptation to the actual situation of the user. Here, the variation can be made available manually, in a motorized manner or in a partially motorized manner. In order to carry out the variation, the control lever is preferably released in its neutral position, the corresponding variation of the first control angle and/or of the second control angle is carried out, and the control lever is fixed or secured again in the new reached neutral position after the variation.

Moreover, it is advantageous if, in a control lever device according to aspects of the invention, the base body has an armrest and/or is fastened to an armrest. The armrest assists the freedom from fatigue further still since, during the use of the control lever, the user then no longer has to hold up or lift his/her arm himself/herself. Here, the armrest can co-define in correlation the inclination or the first control angle. Here, the armrest can be designed to be planar or with a lateral guide for the arm. The armrest is preferably oriented along the direction of travel axis or substantially along the direction of travel axis and/or perpendicular or substantially perpendicular to the vertical axis in the fastening position of the control lever device.

Moreover, advantages are afforded if, in a control lever device according to aspects of the invention, the armrest has an adjusting device for adjusting the orientation of the armrest. In a similar manner to what has already been explained with respect to a variation device, it is possible, here too, for the ergonomics to be still further adapted to the actual user wishes. Here, the orientation of the armrest by adjustment can be designed with respect to the base body, with respect to the vehicle and/or with respect to the control axis of the control lever.

Further advantages can be achieved if, in a control lever device according to aspects of the invention, the base body, the control lever and the armrest form a common structural unit. Such a structural unit can then be arranged by simple and quick assembly with the aid of the fastening interface in the fastening position in the interior of the vehicle. The orientation of the individual components of the structural unit with respect to one another is thus predetermined in a modular manner within this structural unit in a pre-assembly operation, and can in this way combine the advantages according to aspects of the invention with simple and cost-effective assembly. Here, the fastening interface can be arranged directly on the base body and/or on the armrest.

Another subject of the present invention is a vehicle having at least one control lever device according to aspects of the invention. A vehicle according to aspects of the invention thus affords the same advantages as have been comprehensively explained with respect to a control lever device according to aspects of the invention.

### BRIEF DESCRIPTION OF THE DRAWINGS

Further advantages, features and details of the invention will emerge from the description below in which exemplary embodiments of the invention are described in detail with reference to the drawings. Here, the features mentioned in the claims and in the description may be essential to the invention in each case individually by themselves or in any desired combination. In the drawings:

FIG. 1 schematically shows an embodiment of a control lever device according to aspects of the invention,

FIG. 2 schematically shows a further schematic illustration of an orientation possibility according to FIG. 1.

### DETAILED DESCRIPTION OF THE INVENTION

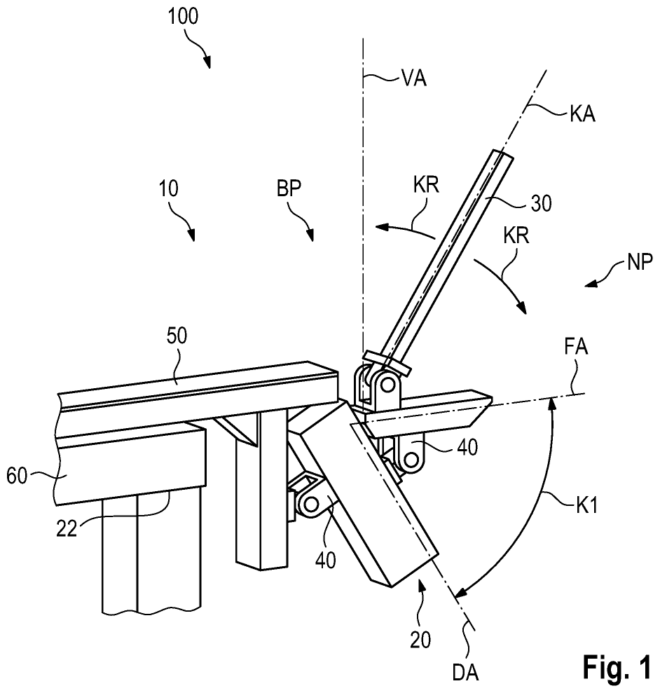

FIG. 1 schematically shows a control lever device 10 according to aspects of the invention in a schematically illustrated vehicle 100. This control lever device 10 is equipped with a base body 20 which, here via an armrest 50, has a fastening interface 22. This fastening interface 22 makes it possible in the vehicle 100 to achieve an assembly in the fastening position BP, as illustrated in FIG. 1.

It can further be seen in FIG. 1 that a defined correlation of the control lever device 10 with the direction of travel axis FA and the vertical axis VA of the vehicle 100 can also be assumed by the defined fastening position BP. This relates for example to the orientation of the armrest 50 approximately perpendicular to the vertical axis VA and along the direction of travel axis FA.

In order to be able to achieve the advantages according to aspects of the invention, the axis of rotation DA of the control lever 30 is then inclined downwardly with respect to the direction of travel axis FA in the neutral position NP. In order to be able to carry out a control movement, the control lever 30 can be moved out of the neutral position NP along the at least one tilting direction KR about the axis of rotation DA. The tilting direction KR here is configured transversely to the direction of travel axis FA and can be equated, for example, with a transverse guidance of the vehicle. Of course, also further tilting directions KR can allow, for example, braking movements and acceleration as well using the control lever 30.

In order to be able to make available further variation possibilities, the control lever device 10 is here equipped with a variation device 40. This variation device 40 allows the variation of the orientation of the control axis KA with respect to that of the vertical axis VA and the direction of travel axis FA. The armrest 50 is also designed with an adjusting device 60, with the result that the armrest 50 can also be adapted with corresponding adjustment possibilities to the actual user ergonomics.

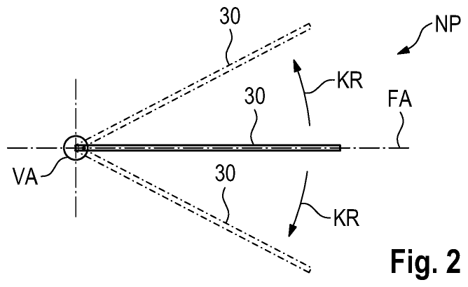

FIG. 2 schematically illustrates a plan view of FIG. 1. Here, the direction of travel axis FA and the vertical axis VA define a plane which extends upwardly perpendicular to the plane of the drawing in FIG. 2.

The above explanation of the embodiments describes the present invention exclusively within the scope of examples. Individual features of the embodiments may of course be freely combined with one another, if technically feasible, without departing from the scope of the present invention.

What is claimed is:

1. A control lever device for a driving operation of a vehicle, said control lever device comprising:
a base body having a fastening interface for fastening to an interior of the vehicle in a fastening position (BP), and
a control lever having an elongate portion extending along a control axis (KA), said control lever being movably mounted on the base body and having a neutral position (NP),
the control lever being mounted for a tilting movement, with respect to the neutral position (NP), in at least one tilting direction (KR) about an axis of rotation which, in the fastening position (BP), is spaced apart from a direction of travel axis (FA) of the vehicle by an acute first control angle (K1), and
wherein the tilting direction (KR) is transverse to the direction of travel axis (FA) of the vehicle.

2. The control lever device as claimed in claim 1, wherein the first control angle is configured to be in a range of about 45°±15°.

3. The control lever device as claimed in claim 1, wherein the axis of rotation has an acute second control angle with respect to a plane passing through the direction of travel axis and a vertical axis, the second control angle being in a range between ±5° and ±10°.

4. The control lever device as claimed in claim 1, wherein the control lever has, along the at least one tilting direction, a tilting clearance which is configured to be less than 900.

5. The control lever device as claimed in claim 4, wherein the tilting clearance is configured to be in the range between ±5° and ±45°.

6. The control lever device as claimed in claim 1, wherein the base body and/or the control lever have/has a variation device for varying the first control angle.

7. The control lever device as claimed in claim 1, wherein the base body has an armrest and/or is fastened to an armrest.

8. The control lever device as claimed in claim 7, wherein the armrest has an adjusting device for adjusting an orientation of the armrest.

9. The control lever device as claimed in claim 7, wherein the base body, the control lever and the armrest form a common structural unit.

10. A vehicle comprising the at least one control lever device having the features of claim 1.
